(19) United States
(12) Patent Application Publication
(10) Pub. No.: US 2001/0049284 A1
(43) Pub. Date: Dec. 6, 2001

(54) System and method for effectively assigning communication frequencies in non-uniform spectrums to cells of a cellular communications network

(76) Inventors: Xiangdong Liu, Germantown, MD (US); Lenwood Heath, Blacksburg, VA (US)

Correspondence Address: Hughes Electronics Corporation, Patent Docket Administration, P.O. Box 956, Bldg. 1, Mail Stop A 109, El Segundo, CA, 90245-0956, US

(21) Appl. No.: 09/737,612

(22) Filed: Dec. 15, 2000

Related U.S. Application Data
(60) Provisional application No. 60/182,921, filed on Feb. 16, 2000.

(51) Int. Cl. H04B 7/185

(52) U.S. Cl. 455/427; 455/430; 455/447; 455/12.1

(57) ABSTRACT

A system and method using a simulated annealing algorithm in a cellular satellite communications network to assign frequency slots to cells in the network. The system and method employ a static stage in which certain frequencies in a non-uniform spectrum are assigned to cells depending upon the predicted traffic demand of all cells, and a dynamic stage which re-evaluates the real time traffic demand of the various cells and assigns or de-assigns frequencies on an as needed basis. The system and method thus delivers more frequencies to cells with a higher capacity enabling those cells to take on more traffic.

The present invention claims benefit under 35 U.S.C. § 119(e) of a provisional U.S. patent application Ser. No. 60/182,921, filed Feb. 16, 2000, the entire contents of which is incorporated herein by reference.

### BACKGROUND OF THE INVENTION

1. Field of the Invention

The present invention relates to a system and method for effectively assigning frequency channels to a cellular communications network with cells that share a non-uniform spectrum, an example being a satellite communications network that uses spot beam technology to form cells, to solve the frequency assignment problem (FAP). More particularly, the present invention relates to a system and method employing a simulated annealing algorithm to optimize assignment of communication frequency to cells of a communications network based on predicted traffic demand and reuse considerations.

2. Description of the Related Art

A cellular communications network, such as a satellite-based cellular communications network, is a telecommunications network that uses frequency channels of a frequency spectrum to transmit data signals and communications traffic. An example of this type of network, and a known method of assigning frequency channels in such a network, is described in a publication by Kuang-Yu Jason Li and Jeffrey E. Outwater entitled “A Frequency Assignment Scheme for GeoMobile Systems Using Spot Beams”, Hughes Space and Communications Company, 1997, which is paraphrased in the following background description.

In this type of network, the entire service area is divided into multiple sub areas (called cells), and each cell is assigned respective frequency channels over which communication can occur between terminals, such as satellite terminal, mobile telephones, and the like, and the communications network. With the use of multiple cells, a cellular system allows the reuse of frequencies in more than one cell to increase the total capacity of a communications network without the need for greater bandwidth. Generally speaking, a satellite cellular network can employ one or more spacecraft, such as a geosynchronous earth orbit (GEO) satellite or low earth orbit (LEO) satellite, to generate spot beans which radiate onto the earth's surface, thus forming the cells of the network and providing the communication frequency channels for the cells. Alternatively, a cellular network can be terrestrially-based and employ base-stations and radio towers which generate the communications frequency channels and thus form the cells of the network. A cellular network may also employ both satellite-based and terrestrial-based technologies.

In cellular networks such as those described above, certain constraints must be satisfied in reusing frequency channels. For example, the same channel typically cannot be used in a cell and its neighboring cells at the same time to avoid interference. This constraint is referred to as neighbor constraint. There may also be an upper limit on the number of times that the same channel can be used in the whole coverage area, which is commonly referred to as a “reuse constraint”. Reuse constraint is needed to minimize the impact of co-channel interference among cells that share the same channel to ensure that the quality of the received signals is maintained.

The optimal or near optimal assignment of channels is a difficult and important problem whose solution leads to improved traffic capacity, thus resulting in increased revenue for the service provider. However, any practical solution to this assignment problem must be implementable in an operational system. In addition, the traffic pattern over the coverage area should not be considered static. Specifically, due to the difference in users, population, and environment, the traffic flow in a cellular system tends to differ from cell to cell. Also, at different times of day, traffic can shift temporarily as well as spatially if, for example, the coverage area occupies several time zones. Other factors, such as special events and holidays, also contribute to the fluctuations of traffic. Thus, traffic in a cellular communication system can be very non-uniform and can vary with time and location. A channel assignment strategy should provide the flexibility to accommodate variations in traffic. As traffic demand fluctuates, a channel assignment scheme should add channels to cells where they are needed and remove channels from cells where they are in excess.

For a ground-based cellular system, the available radio spectrum is usually uniform, meaning that the same frequency range is available to all cells of the system, and each unit of frequency assignment (a channel) of the spectrum has the same traffic bearing capacity. The terms “frequency slot” or “frequency” refer to the unit of frequency assignment for satellite systems. A known method for assigning frequency slots to cells in a ground-based cellular system permanently assigns channels to respective cells to meet the traffic demand of all cells while maintaining low interference between channels in adjacent cells or cells proximate to each other. Although this method may be suitable for ground-based systems, it is not suitable for a satellite-based communications network having frequencies with variable traffic bearing capacity and a non-uniform spectrum, meaning that different frequencies are available for different cells, and some frequencies are not available for all cells.

Another method includes two-stages of assigning frequencies to cells of a satellite-based communications network. In the first stage, frequencies are selectively designated as being preferred to respective cells, and the preferred frequencies satisfy neighbor constraints and maximum reuse constraints. In the second stage, the traffic demands for each cell are monitored, and frequencies are allocated to cells or de-allocated from cells on an as-needed basis. In allocating frequencies to a cell, the preferred frequencies are first considered. If the preferred frequencies have already been allocated to the cell of interest or to other cells, other available frequencies are allocated to the cell of interest. Also, during de-allocation, frequencies that have been allocated to a cell but are not preferred for that cell are de-allocated from that cell first, and then the preferred frequencies are deallocated as necessary.

Although this method is somewhat suitable for handling frequency assignment problems (FAP) in satellite-based communications networks to tackle the dynamic traffic pattern, the first stage of this method requires that the network employ a uniform spectrum or, in other words, that all frequencies in the spectrum have the same traffic-bearing capacity and are available to all cells in the network.

Accordingly, a need exists for a system and method for effectively and efficiently assigning frequencies to cells in a satellite-based communications network employing a non-uniform frequency spectrum.

### SUMMARY OF THE INVENTION

An objective of the present invention is to provide a system and method for efficiently and effectively assigning frequency slots to cells in a satellite-based cellular communications network employing a non-uniform frequency spectrum, to maximize the amount of communications traffic (e.g. telephone calls) that the network can support.

Another objective of the present invention is to provide a system and method for allocating and deallocating frequency slots to cells in satellite-based cellular communications network employing a non-uniform frequency spectrum subject to constraints such as number of reuse of frequencies, neighboring cell interference and frequency availability.

A further objective of the present invention is to provide a system and method for allocating and deallocating frequency slots to cells in a satellite-based communications network using a simulated annealing algorithm.

These and other objectives of the present invention are substantially achieved by providing a system and method for allocating and de-allocating frequencies to cells based on call volume in a satellite based communications network. The various assignment constraints are modeled upon the simulated annealing process. More specifically, the system and method assigns at least one frequency to at least one cell of a plurality of cells of a communications network. The cell is included among one of a plurality of respective groups of cells, each of the respective groups having available to use a respective frequency spectrum, with at least two of the respective frequency spectrums being different from each other. The system and method determine whether any frequency has been assigned to any cell within a predetermined distance from the cell, select at least one frequency from among the respective frequency spectrum available to that one respective group of cells, and other than any frequency already allocated to a cell in proximity, and assign the selected frequency to the cell.

The above objectives, as well as other objectives also can substantially be achieved by providing a system and method for assigning frequencies to a plurality of cells of a communications network. The system and method generates a matrix including a number of elements, the number being equal to a total number of the cells multiplied by a total number of the frequencies, each of the elements including a first field identifying a respective cell and a second field identifying a respective frequency from among the frequencies. Each element of the matrix also has an indicator having 2 possible states. For each of the elements, the system and method generates a fist state in the indicator when the respective frequency identified by the second field is assigned to the cell identified by the first field, and generating a second state in the indicator when the respective frequency identified by the second field is not assigned to the cell identified by the first field.

### BRIEF DESCRIPTION OF THE DRAWINGS

These and other objects, advantages and novel features of the invention will be more readily appreciated from the following detailed description when read in conjunction with the accompanying drawings, in which:

FIG. 1 is a schematic diagram of a satellite communications network employing a system and method for assigning communication frequencies to cells according to an embodiment of the present invention;

FIG. 2 is a schematic block diagram of a satellite, a base station and an access terminal included in the satellite communications network shown in FIG. 1;

FIG. 3 is a diagram illustrating an example of geographic cell coverage provided by the satellite shown in FIG. 2;

FIG. 4 is a frequency distribution graph illustrating an example of a non-uniform distribution of spectrum across the cells provided by the satellite communications network shown in FIG. 1;

FIG. 5 is a graph illustrating an example of the spectrum and corresponding frequency slots available to a cell provided by the communications network shown in FIG. 1;

FIG. 6 is a flowchart illustrating exemplary steps performed by the frequency assignment system and method according to the embodiment of the present invention employed in the satellite communications network shown in FIG. 1; and

FIG. 7 is another flowchart illustrating exemplary steps performed by the frequency assignment system and method according to the embodiment of the present invention employed in the satellite communications network shown in FIG. 1

### DETAILED DESCRIPTION OF THE PREFERRED EMBODIMENTS

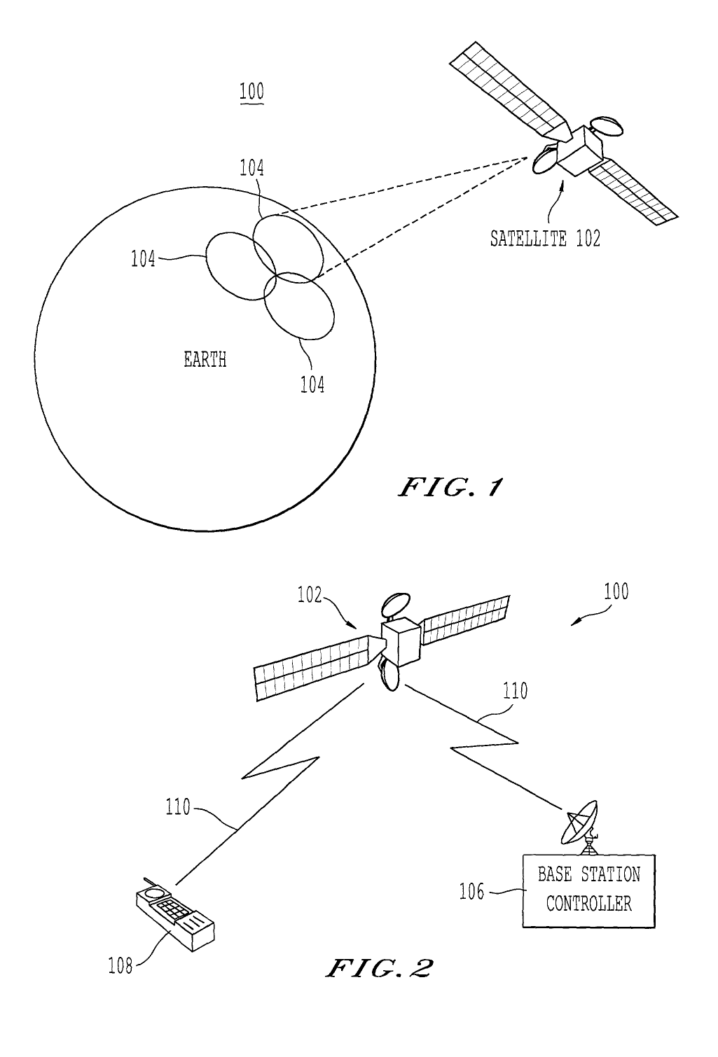

An example of a satellite-based cellular communications network 100 employing a frequency assignment system and method according to an embodiment of the present invention is shown in FIGS. 1 and 2. As illustrated, the network 100 includes at least one satellite 102, such as a geosynchronous earth orbit (GEO) satellite or low earth orbit (LEO) satellite, that generates at least one spot beam 104 onto a pre-determined geographic location on the surface of the earth for communication with a plurality of access terminals.

As shown in more detail in FIG. 2, the network 100 employs a base station controller 106, which controls operations of the network 100 as described in more detail below, and a plurality of access terminals 108, such as hand-held or vehicle-mounted telephones, or any other type of transceiver terminals. The access terminals 108 are each adapted to receive and transmit communications signals, such as voice data or multimedia data, for example, to and from the satellite 102 over one or more communications frequency channels 110 which is described in more detail below. This enables an access terminal 108 to communicate with, for example, the base station controller 106 of the network 100 or another access terminal (not shown) via the satellite 102 as can be appreciated by one skilled in the art.

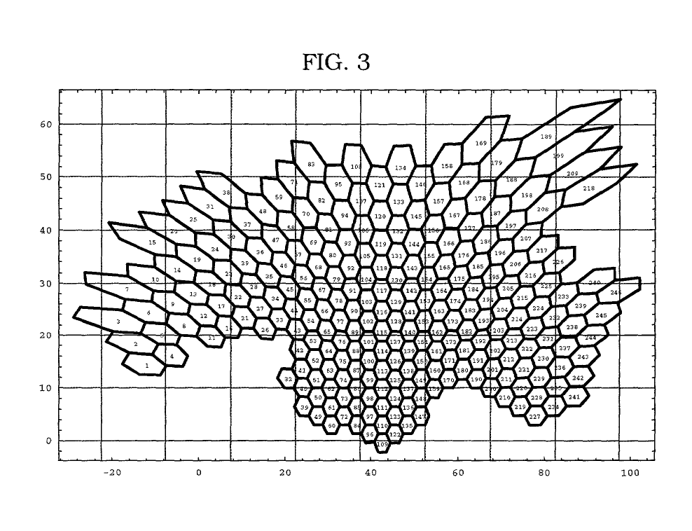

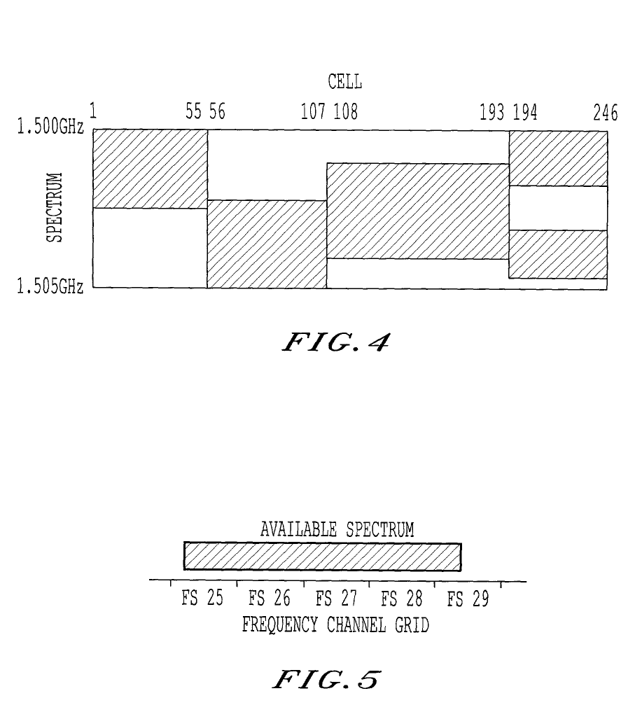

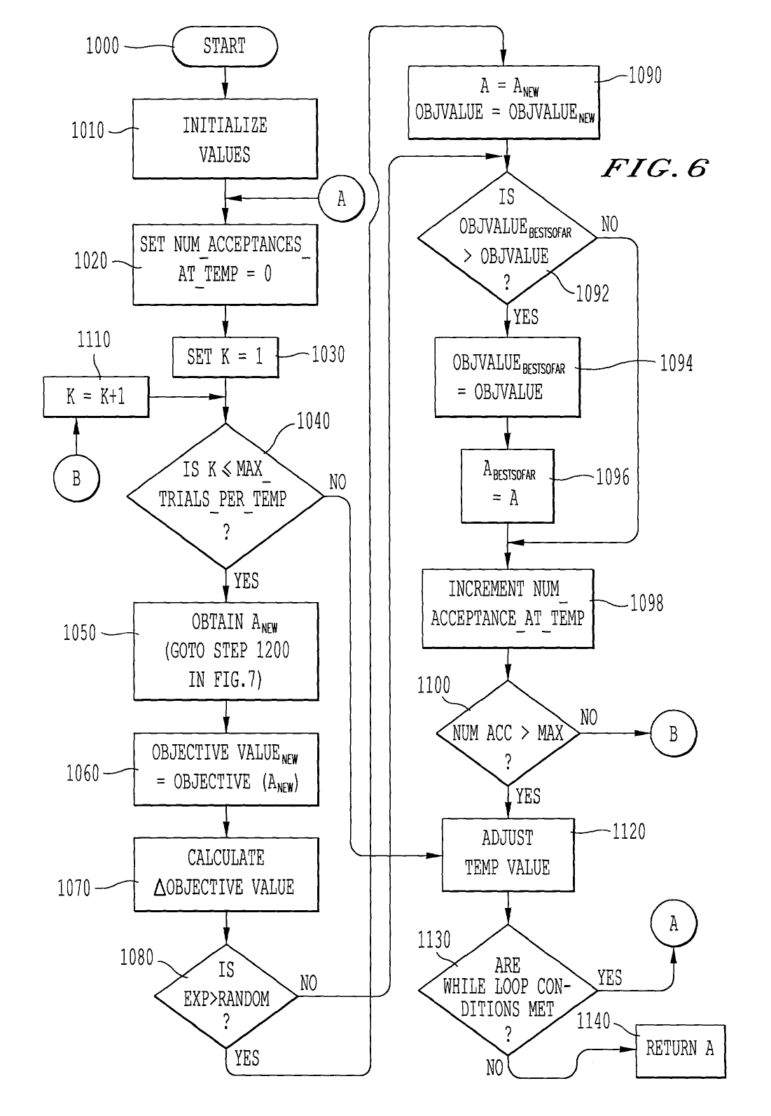

That is, in a GEO satellite cellular communications network such as network 100 shown in FIG. 1, the spot beams 102 typically cast hundreds of cells C as illustrated in FIG. 3, with each cell C covering a particular geographic area. Each cell C or area generates its own traffic, such as telephone calls, page requests data communications and the like. The system operator of the network 100 negotiates with certain regulatory organizations (e.g. ITU and government agencies) and other communications system operators to acquire the right to use certain radio spectrum As shown in FIG. 4, the spectrum is not typically uniform across all cells C. In this example, cells 1 through 55, 56 through 107, 108 through 193 and 194 through 256 are segregated into four respective groups, with each group being made available a respective portion or portions of the available communications frequency spectrum Typically, a satellite communications network 100 of the type shown in FIGS. 1 and 2 operates on a fixed grid of frequency slots (FS). In one design, an FS is further divided into five sub-units called carriers, although a frequency slot is still the unit of spectrum allocation to cells. For a particular cell C, the available spectrum translates into a set of frequency slots where not all frequency slots have the same traffic-bearing capacity, as illustrated in FIG. 5. For example, FS 25 in FIG. 5 is a “partial FS” that has only four carriers, or 80% capacity of a full FS, such as FS 26, FS 27 and FS 28. FS 29 is also a partial FS, with only 40% capacity of a full FS.

In the cellular satellite communications network 100, or any cellular communications network such as a terrestrial cellular network, it is necessary to reuse the same frequencies in different cells due to the limited number of available frequencies. In the case of a satellite-based network, if two cells are sufficiently far apart, they can use (or reuse) the same frequency without incurring a high level of interference. In one example, the distance criterion is designed or determined to be the two-layer neighborhood of cells. In the cell pattern shown in FIG. 3, for example, cell 103 can share frequencies with cell 80, but not with adjacent cells 90, 91, 104, 117, 116, 102 or with cells 77, 78, 79, 92, 105, 118, 117, 116, 115, 101 and 89 which are in close proximity to cell 103. To control the overall interference level, the network 100 may also place a limit on how many times a particular frequency can be reused, which is referred to as the “maximum reuse number”.

The volume of traffic (e.g., the number of telephone calls) from a cell C depends upon the population and economic development level in the area covered by the cell C. Traffic volume can be predicted from market study or from data collected from a communications network once it has been in operation for some time.

Given a particular traffic volume, the amount of spectrum needed to serve the traffic to keep the blocking rate below a certain acceptable level (e.g. 2%) can be calculated according to Erlang theory. In other words, the number of carriers needed for a cell C can be calculated from the predicted traffic in the cell C. If fewer than the needed number of carriers are assigned to the cell C, a higher percentage of calls from the cell C is expected to be blocked.

As will now be described, the FAP according to an embodiment of the present invention for a GEO satellite cellular communications network assigns frequency slots for all cells C such that the number of carriers in the frequency slots assigned to each cell C is as close to the number needed as possible for the cell C or even higher, while satisfying the following 3 constraints:

1. Neighbor constraint: no cell C is assigned a frequency that is also assigned to one of its two layer neighbor cells C;

2. Reuse constraint: no frequency is reused more times than its maximum reuse number.

3. Availability constraint: only frequencies available to a cell C can be assigned to the cell C.

As described in the Background section above, the first stage of a known frequency assignment method for a satellite-based cellular system assigns certain frequencies to a cell as preferred frequencies. The lists of preferred frequencies then guide the second stage of the method to allocate frequencies to the cells in real time. If the real-time traffic pattern is close to that predicted, the allocation of frequencies to each cell is similar to its list of preferred frequencies. However if the real-time traffic deviates from that predicted, the second stage still has the freedom to allocate a frequency to a cell where that frequency is not preferred. The list of preferred frequencies for that cell guides the second stage to de-assign a frequency that is not preferred whenever possible on falling traffic demand, thus leading the frequency assignment across all cells back towards the pattern of preferred frequencies.

It is noted that the first stage of the known method essentially performs a static assignment of frequencies and therefore applies to a terrestrial-based cellular network, and only the second stage of the method interprets that assignment as preferences. An embodiment of the present invention can be used as a stand alone-method-static assignment technique, or can be combined with stage 2 of Li-Outwater method. Therefore, according to an embodiment of the present invention, the first stage can be modeled as a static frequency assignment task as follows, with M representing the total possible number of frequency slots applicable to the system and N representing the number of cells. The availability of spectrum is represented by an M by N matrix L such that

L[i, j]=number of carriers that frequency slot i has at cell j

Given a particular predicted traffic volume for a cell j and a target grade of service, the number of carriers needed for the cell j can be calculated. This number is represented by D[j], with j=1, 2, . . . , N. For any cell j, traffic volume changes over the course of a day and exhibits a diurnal pattern. For static assignment purposes, D[j] is calculated from the peak traffic volume of cell j.

The assignment of frequency slots to different cells is represented by an M by N matrix A as follows.

$$A [ i , j ] = \{ \begin{matrix}1 & if frequency slot i is assigned to cell j \\ 0 & if frequency slot i is not assigned to cell j\end{matrix}$$

For a valid assignment A, A[i,j] can be 1 only if L[i,j]>0. For each cell j, a set N[j] is formed that consists of all the two-layer neighbor cells of j. If A[i,j]=1, it implies that A[i,k]=0 for all cells k εN[j]. The sum of column j of A is the total number of frequency resources (in terms of FSs) assigned to cell j, and the sum of row i of A is the number of reuse of frequency slot i. Let R[i] represent the maximum reuse number of frequency slot i, and each row sum of A then should be no greater than the corresponding R[i].

Each use of a frequency slot consumes some other system resources, such as hardware and there is a limit P of these other resources. The summation of all elements of A is the total number of use of all frequency slots, and it is therefore required that

$${\sum }_{i = 1}^{M} {\sum }_{j = 1}^{N} A [ i , j ] \leq P$$

However, it is almost always the case that the available spectrum is the bottleneck of system resources, and thus the value of P does not constitute a real constraint.

How much a particular assignment A satisfies the traffic demand can be represented by a short-fall function S(A):

$$S ( A ) = {\sum }_{j = 1}^{N} max ( 0 , D [ j ] - {\sum }_{i = 1}^{M} A [ i , j ] L [ i , j ] )$$

S(A)=0 means that traffic demand from all cells is satisfied, and S(A)>0 means that demand from some cells is not satisfied. If a cell is assigned more frequencies than it needs, the extra frequencies do not reduce the short-fall.

The static frequency assignment problem can now be formulated as follows: minimize

$$S ( A ) = {\sum }_{j = 1}^{N} max ( 0 , D [ j ] - {\sum }_{i = 1}^{M} A [ i , j ] L [ i , j ] )$$

subject to

| | | |
|---|---|---|
| A[i, j] = 1 | only if L[i, j] > 0 | (availability constraint) |
| A[i, j] = 1 | only if A[i, k] = 0 ∀k ε N[j] | (neighbor constraint) |
| A[i, j] = 1 | only if A[i, k] = 0 ∀k ε N[j] | (neighbor constraint) |
| ${\sum }_{j = 1}^{N} A [ i , j ] \leq R [ i ]$ | | (reuse constraint) |
| ${\sum }_{i = 1}^{M} {\sum }_{j = 1}^{N} A [ i , j ] \leq P$ | | (other resources constraint) |

Again, the last constraint above may not be a real constraint in practice and often needs not be considered.

In optimization theory, the shortfall function above is called the “objective function” which will be referred to in the following description. As will now be described, the system and method according to an embodiment of the present invention applies a simulating annealing algorithm to select frequencies to assign to cells of a cellular communications network, such as satellite-based cellular communications network 100 described above, or any other satellite-based or terrestrial cellular communications network.

As can be appreciated by one skilled in the art, simulated annealing is a general optimization technique that originates from the analogy of the physical process of annealing solids to solving large combinatorial optimization problems. In condensed matter physics, annealing is the process of heating a solid compound until it melts and then letting it cool down very slowly to crystallize. The molecules of a solid form a particular structure and the structure possesses a certain amount of free energy. Molecules in a crystal have a lattice structure that possesses the minimum amount of free energy. If the compound cools down too quickly, imperfections may occur in the resulting crystal, indicating a larger than minimum free molecular energy.

Simulated annealing models the physical annealing process and relates the objective function of an optimization problem to the free molecular energy of an imaginary compound. Simulated annealing is an iterative procedure and the number of iterations is analogous to the time allowed for a melted compound to cool down. The procedure essentially is a controlled random search. To absolutely minimize the objective function, the number of iterations may be extremely large. In practice, a maximum number of iterations is usually specified and the resulting solution may not carry the minimum objective function value but some value close to the minimum.

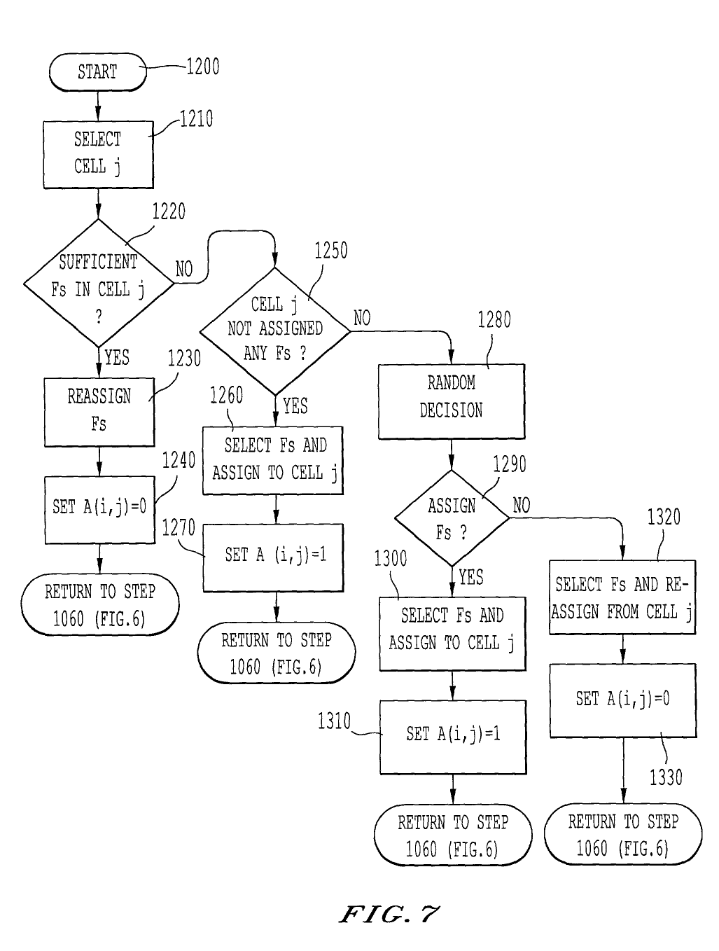

Adapted to the static frequency assignment problem, the simulated annealing methodology includes two procedures which are represented in pseudo-code and discussed below, and illustrated in the flowcharts of FIGS. 6 and 7. The first procedure is the general logic structure of simulated annealing and does not have any real bearing on static frequency assignment problem, except for the two function calls Objective( ) and GenerateNewSolution( ) which link (or apply) simulated annealing to the frequency assignment problem being solved. In the first procedure, some variables and most constants have names related to the physical annealing process. As can be appreciated from the following description, these variables and constraints are used to illustrate the logic control of the procedure and do not have any exact meaning to the frequency assignment problem being solved.

Pseudo Code For Procedure 1 (Heating and Cooling)

Input: matrix A of all 0's (no assignment)

Output: an assignment matrix A with the lowest objective function value that the algorithm can find in the allowed amount of calculation.

Procedure:

Begin

Temperature=T_{MELTING};

ObjectiveValue =S(A); /*initial value of function S(A) with A =0*/

ObjectiveValue_{BEST}_{_{—}}_{SO}_{_{—}}_{FAR}=ObjectiveValue;

A_{BEST}_{_{—}}_{SO}_{_{—}}_{FAR}=A;

TemperatureDecreaseFactor=TEMP_DEC_FACTOR;

Do
{ Num_Acceptances_At_Temperature = 0;

For (k=1; k<=MAX_TRIALS_PER_TEMIPERATURE; k=k+1)
{ A_{new} = GenerateNewSolution(A); /*Procedure

2*/

ObjectiveValue_{new} = S (Anew); /*per function S(A)*/
ΔObjectiveValue = ObjectiveValue_{new} − ObjectiveValue;
If (Exp(−ΔObjectiveValue/Temperature) > Random[0,1))
{ A = A_{new};

ObjectiveValue = ObjectiveValue_{new};
If (ObjectiveValue_{BEST}_{_{—}}_{SO}_{_{—}}_{FAR} > ObjectiveValue);
{
ObjectiveValue_{BEST}_{_{—}}_{SO}_{_{—}}_{FAR} = ObjectiveValue;

A_{BEST}_{_{—}}_{SO}_{_{—}}_{FAR} = A;

}
Num_Acceptance At_Temperature++;
}
If ((Num_Acceptance_At_Temperature

MAX_NUM_ACCEPTANCE_PER_TEMPERATURE)

Break;
Temperature = Temperature*TemperatureDecreaseFactor;
TemperatureDecreaseFactor =
TemperatureDecreeaseFactor*TEMP_DEC_FACTOR;

}While ((Temperature > T_{FREEZING})And
(Num Acceptance_At_Temperature > 0))
A = A_{BEST}_{_{—}}_{SO}_{_{—}}_{FAR};
Return A;
End

A_{BEST}_{_{—}}_{SO}_{_{—}}_{FAR} stores the best solution found so far. ObjectiveValue_{BEST}_{_{—}}_{SO}_{_{—}}_{FAR} is the objective function value associated with the best solution found so far. For a system with on order of 300 cells and 250 total frequency slots, the following constant values are adequate:

T_{MELTING}=20

TEMP_DEC_FACTOR=0.999

MAX_TRIALS_PER_TEMPERATURE=50*M*N

MAX_NUM_ACCEPTANCE_PER_TEMPERATURE=100*N

T_{FREEZING}=0.1

where M is the total number of frequencies, and N the number of cells.

Pseudo Code For Procedure 2 (New Assignment Generation)

| | |
|---|---|
| Input: | an assignment matrix A |
| Output: | a new assignment matrix |

Procedure:

Randomly select a cell j;

If (cell j already is assigned sufficient FSs)

Then randomly select FS i, one of the FSs assigned to cell j and
remove it from j: A[i,j] = 0;
Else If (cell j is not yet assigned any FS)

Then randomly select an FS i that can still be assigned to cell j and
assign FS i to cell j: A[i,j] = 1;
Else {randomly decide whether to assign an ES from cell j
or remove an FS from cell j;

If (to assign an FS)
Then randomly select an FS i that can still be assigned to cell j
and assign FS ito cell j:
A[i,j] = 1;
Else randomly select FS i, one of the FSs assigned to cell j and
remove it from j: A[i,j] = 0;
}

Return A

In Procedure 1 illustrated above, the function Random[0,1) returns a random number in the interval of [0,1) (i.e., the random number can include “0” but must be less than “1”), and Exp( ) is the natural exponential function. T_{FREEZING}, T_{MELTING}, MAX_TRIALS_PER_TEMPERATURE and MAX_ACCEPTANCE_PER_TEMPERATURE are constants that control the number of iterations to be carried out, and their values are determined from experiments. It is also noted that the term “A=0” refers to the matrix A, and indicates that all values of the matrix A are “0” (i.e., all values of A[i,j] are set to “0”), meaning that no frequency slots have been assigned to any cells. The lines

Temperature=Temperature* TemperatureDecreaseFactor;

TemperatureDecreaseFactor=

TemperatureDecreaseFactor*TEMP_DEC_FACTOR;

form a “cooling schedule” which controls how temperature is lowered. Many variations are possible. The above schedule is preferred because it lowers temperature very slowly when the temperature is either high or low and it lowers temperature quickly when temperature is in mid range. It turns out that most progress towards finding a good solution is made when temperature is either high or low and little progress occurs in mid range temperatures.

Procedures 1 and 2 will now be described in more detail as they apply to the frequency assignment problem with reference to the flowcharts shown in FIGS. 6 and 7. The processing performed by procedures 1 and 2 and as shown in the flowcharts of FIGS. 6 and 7 can be performed by a processor in the base station controller 106 (see FIG. 2) or any other suitable component of the network 100. Also, as mentioned above, these procedures can be used in any type of cellular communications network, such as any type of cellular satellite-based communications network including GEO satellites, LEO satellites, or a combination of both, a terrestrial cellular communications network, a combined satellite and terrestrial network, and so on.

As shown in step 1000 in FIG. 7, the frequency assignment process begins with the processing according to procedure 1. In step 1010, the processing sets the initial values for Temperature and ObjectiveValue. As will be appreciated from the following, the number of iterations performed by the “DO-WHILE” loop is impacted by the value at which the variable Temperature is initially set. The value to which the variable ObjectiveValue is initially set is based on the function for S(A) set forth above, which provides an indication as to the total number of frequency assignments that still need to be satisfied for all of the cells.

The processing then proceeds to the “DO-WHILE” loop beginning in step 1020. In this step, the processing sets the variable Num_Acceptances_At-Temperature to “0”. This variable monitors how much improvement in the frequency assignment process has been made at a particular temperature, i.e., for each iteration of the DO-while loop. The processing then proceeds to the beginning of the “FOR” loop at step 1030, in which the value of “k” for the loop is initialized to “0”. In step 1040, the processing determines whether the value of k is less than the value of the “MAX_TRIALS_PER_TEMPERATURE” variable, which has been set to a value in accordance with which the number of iterations of the “FOR” loop is impacted. If so, the processing proceeds to step 1050 where the value of the matrix A_{new} is determined in accordance with Procedure 2 and the flowchart shown in FIG. 7 as will now be described.

That is, the processing skips to step 1200 of the flowchart shown in FIG. 7 where an assignment of a frequency to a cell is performed. In step 1210, the processing randomly selects a cell and determines in step 1220 whether that cell has already been assigned a sufficient amount of frequencies to support its traffic. If the processing determines that cell j has been assigned a sufficient amount of frequencies, the processing randomly selects one of the frequencies assigned to cell j and unassigns it from cell j in step 1230. The processing then sets the value of the matrix A[i,j] equal to “0” for those particular i and j values, indicating that slot “i” is no longer assigned to cell j. The processing then returns to step 1060 in the flowchart of FIG. 6 and continues as discussed below.

However, if the processing determines in step 1220 that randomly selected cell j has not been assigned a sufficient amount of frequencies, the processing proceeds from step 1220 to step 1250, where it determines whether cell j has been assigned any frequencies. If cell j has not been assigned any frequency, the processing in step 1260 selects a frequency that can be assigned to cell j based on reuse considerations, and assigns that frequency to cell j. In step 1270, the processing then sets the value of the matrix A[i,j] equal to “1” for those particular i and j values, indicating that slot “i” has been assigned to cell “j”. The processing then returns to step 1060 in the flowchart of FIG. 6 and continues as discussed below.

However, if the processing determines in step 1250 that randomly selected cell j has been assigned at least one frequency, the processing proceeds from step 1250 to step 1280 where it randomly decides whether to assign a frequency to cell j or to unassign a frequency from cell j. If the processing determines in step 1290 that a frequency is to be assigned to cell j, the processing proceeds to step 1300 where it selects a frequency that can be assigned to cell j based on reuse considerations, and assigns that frequency to cell j. In step 1310, the processing then sets the value of the matrix A[i,j] equal to “1” for those particular i and j values, indicating that slot “i” has been assigned to cell “j”. The processing then returns to step 1060 in the flowchart of FIG. 6 and continues as discussed below.

If the processing determines in step 1290 that a frequency is to be unassigned from cell j, the processing proceeds to step 1320, where it randomly selects one of the frequencies assigned to cell j and unassigns it from cell j. In step 1330, the processing then sets the value of the matrix A[i,j] equal to “0” for those particular i and j values, indicating that slot “i” is no longer assigned to cell j. The processing then returns to step 1060 in the flowchart of FIG. 6 and continues as discussed below.

Once Procedure 2 has returned a value for matrix A_{new} as discussed above, the processing in step 1060 assigns a value to variable ObjectiveValue_{new} according to function S(A) set forth above, using the matrix A_{new} in that function. The processing then determines the change in the values of ObjectiveValue_{new} and ObjectiveValue in step 1070, which is represented by the variable ΔObjectiveValue. This variable essentially indicates the effect of the frequency assignment or removal in Procedure 2 that has just been performed. A positive value for ΔObjectiveValue indicates that a frequency was assigned, and a negative value indicates that a frequency was removed. The processing then determines in step 1080 whether the value of the exponent is greater than a random number generated which can be any number between 0 and 1, including 0 but not including 1. The step 1080 is referred to as the Metropolis criterion.

If the exponent value is greater than the random number, then the processing proceeds to step 1090 where the values in matrix A are assigned the corresponding values of matrix A_{new}, and the value of ObjectiveValue is assigned the value of ObjectiveValue_{new}. The processing then turns to determine whether the objective value best so far is greater than the objective value, as shown in step 1092. If the objective value best so far is indeed greater, then step 1094 sets the objective value best so far at the objective value. The processing proceeds to step 1096 to set A_{BEST}_{_{—}}_{SO}_{_{—}}_{FAR} at A. If the processing determines that the objective value best so far is not greater than the objective value, then the processing proceeds to step 1098, and the value of NUM_ACCEPTANCE_AT_TEMP is incremented by 1, meaning that one more new frequency assignment has been made during this iteration of the Do-While loop. The processing then proceeds to step 1100. If, however, the processing determines in step 1080 that the value of the exponent is not greater than the random number, the processing proceed directly to step 1100 without performing steps 1090 through 1098.

In step 1100, the processing determines whether the Num_Acceptance_At_Temp is greater than the MAX_ACCEPTANCE_PER_TEMPERATURE, meaning that the number of frequency reassignments permitted for that iteration of the DO-WHILE loop has been exceeded, or whether the value of ObjectiveValue is equal to “0”. If neither condition is met, the processing proceeds to step 1110 where the value of variable k is incremented by 1, and the processing returns to step 1040 and repeats as discussed above. However, if either condition in step 1100 is met, the processing proceeds to step 1120 where the value of variable Temperature is adjusted as indicated. It is also noted that if the condition in step 1040 is not met, that is, if the value of k is not less than or equal to the value of the variable MAX_TRIALS_PER_TEMPERATURE, the processing proceeds from step 1040 to step 1120 without performing any of the intermittent steps described above.

After adjusting the value of the variable Temperature in step 1120, the processing determines in step 1130 whether the value of variable Temperature is greater than the value of variable T_{FREEZING} which has been initialized at a certain value. The processing also determines in step 1130 whether the value of variable Num_Acceptance_At_Temp is greater than 0. If both conditions are not met, the processing returns to step 1020 and repeats as discussed above. However, if both conditions are met, the processing proceeds to step 1140, where the matrix A indicates the frequency assignments for the cells C in the network 100.

It is also noted that many embodiments for frequency assignment are possible for Procedure 2 discussed above. However, in these variations, two issues remain essential: 1) all constraints are enforced in the procedure in selecting appropriate FSs (instead of reflecting the constraints in the objective function as a general simulated annealing practitioner may do); and 2) the procedure must be able to perform both assignment and removal of FSs to allow low quality assignment matrices to be abandoned.

To demonstrate the flexibility of the procedures described above, one embodiment adds more desired objectives into consideration in making frequency assignment. In this embodiment, frequency slots are distinguished between those used to carry telephone traffic only and those that also carry certain control signals as well as some traffic. Each cell must be assigned one control signal frequency slot, the number of frequency slots used across all cells to carry control signals must be minimized, and the control signal frequency slots must be as full as possible. On top of a control signal frequency slot, each cell may also need traffic frequency slots. In assigning traffic frequency slots, extremely “hungry” cells need to be avoided. That is, in case there are not sufficient frequency slots to satisfy the demand of all cells, the process should avoid having one cell with no traffic frequency slot at all, while its neighboring cells have all their demand satisfied.

In addition, an aggressive assignment strategy is adopted. That is, in each of steps 1260 and 1300 a frequency i is randomly selected subject only to its reuse constraint. Then a check is made in neighbor cells of the already selected cell j to determine if frequency i has been assigned to any of them. If so, frequency i is removed from these cells. Frequency i is then assigned to cell j. Furthermore, another check is made to determine if any neighbor cells of those neighbor cells of cell j, from which frequency i has just been removed, can now be assigned frequency i based on cell demand and neighbor and reuse constraints. If so, frequency i is assigned to those neighbor-of-neighbor of cell j as well.

To achieve the desired outcome in this variation, the simulated annealing process described above is performed twice, each time using a different objective function. The first run assigns control signals frequency slots, and the second run assigns “traffic only” frequency slots. The maximum reuse number of a frequency slot for the second run is the original maximum reuse number reduced by the number of times that frequency slot is assigned in the first run.

Also, for assigning control signal frequency slots, the demand of each cell is set to be 1, that is D[j]=1, and the objective function is revised to incorporate those desired objectives for control signal frequencies. In addition, the objective function is to be maximized.

$${S}_{1} ( A ) = {\sum }_{j = 1}^{N} {\sum }_{i = 1}^{M} A [ i , j ] ( 1 + auxiliary ( {\sum }_{k = 1}^{N} A [ i , k ] {( \frac{L [ i , j ]}{5} )}^{3} ) )$$

where the function auxiliary(x) is defined as

$$auxiliary ( x ) = \{ \begin{matrix}0 & if x = 0 \\ \frac{x - c}{2 ( c - 1 )} & if x \leq c \\ 2 ( x - c ) & if x > c\end{matrix}$$

where c=4.

Literally, the above objective function gives weight to the assignment of a frequency slot that is already used many times and has close to five carriers.

For assigning “traffic only” frequency slots, the demand of a cell is adjusted from the original number of needed carriers to take into account the number of carriers in the control signal FS that can be used to serve traffic, and the following objective function is maximized:

$${S}_{2} ( A ) = {\sum }_{j = 1}^{N} {\sum }_{i = 1}^{M} A [ i , j ] ( D [ j ] - {\sum }_{k = 1}^{M} A [ k , j ] L [ k , j ] + \frac{L [ i , j ]}{2} ) L [ i , j ]$$

This function essentially gives weight to a carrier assigned to a cell when the total number of carriers assigned to the cell is significantly smaller than the traffic demand, and the weight becomes smaller once the total number of carriers assigned is close to the demand. Since procedure 1 is to minimize an objective function, we simply make the following substitution to apply procedure 1:

S(A)=−S₁(A) or S(A)=−S₂(A)

Although only several exemplary embodiments of the present invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

What is claimed is:

1. A method for allocating at least one frequency to at least one cell of a plurality of cells of a communications network, said cell being included among one of a plurality of respective groups of said cells, each of said respective groups having available a respective frequency spectrum, at least two of said respective frequency spectrums being different from each other, the method comprising the steps of:
determining whether any frequency has been assigned to any cell within a predetermined distance from said cell;
selecting at least one frequency from among said respective frequency spectrum available to said one respective group of cells, and other than said any frequency; and
assigning said selected frequency to said cell.

2. A method as claimed in claim 1, wherein:
said determining step determines which frequencies have been assigned to any cells within said predetermined distance from said cell;
said selecting step selects a plurality of frequencies from among said respective frequency spectrum available to said one respective group of cells, and other than any of said frequencies that have been assigned to said cells within said predetermined distance from said cell; and
said allocating step assigns said plurality of frequencies to said cell.

3. A method as claimed in claim 1, further comprising the steps of:
determining which frequencies have been assigned to which of said cells; and
removing at least one of said frequencies from at least one of said cells; and
wherein said selecting step selects said at least one of said frequency from among said at least one of said frequencies removed in said removal step.

4. A method as claimed in claim 1, wherein:
said communications network comprises a satellite-based communications network including at least one satellite which generates at least one spot beam including said cells; and
said determining, selecting and assigning steps perform their respective operations on said cells included in said spot beam.

5. A method as claimed in claim 1, wherein:
said at least two frequency spectrums includes at least one of the same frequencies.

6. A method for allocating frequencies to a plurality of cells of a communications network, the method comprising the steps of:
generating a matrix including a number of elements, said number being equal to a total number of said cells multiplied by a total number of said frequencies, each of said elements including a first field identifying a respective said cell and a second field identifying a respective frequency from among said frequencies; and
for each of said elements, providing a first indicator in said second field when said respective frequency identified by said second field is assigned to said cell identified by said first field, and providing a second indicator in said second field when said respective frequency identified by said second field is not assigned to said cell identified by said first field.

7. A method as claimed in claim 6, further comprising the steps of:
assigning at least one frequency to at least one of said cells; and
modifying the one of said elements whose first field identifies said one of said cells and said second field identifies said frequency so that said second field includes said first indicator indicating that said frequency is assigned to said one of said cells.

8. A method as claimed in claim 7, wherein:
said assigning step assigns a plurality of frequencies to a plurality of said cells; and
said modifying step modifies those of said elements whose respective first fields identify those of said cells to which said frequencies have been assigned and said respective second fields identify said assigned frequencies so that said second fields each include said first indicator indicating that their representative frequency is assigned to their respective cell.

9. A method as claimed in claim 6, further comprising the steps of:
removing at least one frequency from at least one of said cells; and
modifying the one of said elements whose first field identifies said one of said cells and said second field identifies said frequency so that said second field includes said second indicator indicating that said frequency has been removed from said one of said cells.

10. A method as claimed in claim 9, wherein:
said removing step removes a plurality of frequencies from a plurality of said cells; and
said modifying step modifies those of said elements whose respective first fields identify those of said cells from which said frequencies have been removed and said respective second fields identify said removed frequencies so that said second fields each include said second indicator indicating that their representative frequency has been removed from their respective cell.

11. A method as claimed in claim 6, wherein:
said network segregates said cells into a plurality of respective groups of said cells, each of said respective groups having available a respective frequency spectrum, one of said respective frequency spectrums including certain of said frequencies different from any frequencies in at least one other of said frequency spectrums; and
said method includes the steps of:
assigning to at least one of said cells at least one frequency from among said frequencies included in said frequency spectrum assigned to said group including said at least one cell; and
modifying the one of said elements whose first field identifies said one of said cells and said second field identifies said at least one frequency so that said second field includes said first indicator indicating that said frequency has been assigned to said one of said cells.

12. A computer-readable medium of instructions for assigning at least one frequency to at least one cell of a plurality of cells of a communications network, said cell being included among one of a plurality of respective groups of said cells, each of said respective groups having available a respective frequency spectrum, at least two of said respective frequency spectrums being different from each other, the instructions comprising:
a first set of instructions for determining whether any frequency has been assigned to any cell within a predetermined distance from said cell;
a second set of instructions for selecting at least one frequency from among said respective frequency spectrum available to said one respective group of cells, and other than said any frequency; and
a third set of instructions for assigning said selected frequency to said cell.

13. A computer-readable medium of instructions as claimed in claim 12, wherein:
said first set of instructions determines which frequencies have been assigned to any cells within said predetermined distance from said cell;
said second set of instructions selects a plurality of frequencies from among said respective frequency spectrum available to said one respective group of cells, and other than any of said frequencies that have been assigned to said cells within said predetermined distance from said cell; and
said third set of instructions assigns said plurality of frequencies to said cell.

14. A computer-readable medium of instructions as claimed in claim 12, further comprising:
a fourth set of instructions for determining which frequencies have been assigned to which of said cells; and
a fifth set of instructions for removing at least one of said frequencies from at least one of said cells; and
wherein said second set of instructions selects said at least one of said frequency from among said at least one of said frequencies removed in said removing step.

15. A computer-readable medium of instructions as claimed in claim 12, wherein:
said communications network comprises a satellite-based communications network including at least one satellite which generates at least one spot beam including said cells; and
said first, second and third sets of instructions perform their respective operations on said cells included in said spot beam.

16. A computer-readable medium of instructions as claimed in claim 12, wherein:
said at least two frequency spectrums includes at least one of the same frequencies.

17. A computer-readable medium of instructions for allocating frequencies to a plurality of cells of a communications network, the instructions comprising:
a first set of instructions for generating a matrix including a number of elements, said number being equal to a total number of said cells multiplied by a total number of said frequencies, each of said elements including a first field identifying a respective said cell and a second field identifying a respective frequency from among said frequencies; and
a second set of instructions which, for each of said elements, provides a first indicator in said second field when said respective frequency identified by said second field is assigned to said cell identified by said first field, and providing a second indicator in said second field when said respective frequency identified by said second field is not assigned to said cell identified by said first field.

18. A computer-readable medium of instructions as claimed in claim 17, further comprising:
a third set of instructions for assigning at least one frequency to at least one of said cells; and
a fourth set of instructions for modifying the one of said elements whose first field identifies said one of said cells and said second field identifies said frequency so that said second field includes said first indicator indicating that said frequency is assigned to said one of said cells.

19. A computer-readable medium of instructions as claimed in claim 18, wherein:
said third set of instructions assigns a plurality of frequencies to a plurality of said cells; and
said fourth set of instructions modifies those of said elements whose respective first fields identify those of said cells to which said frequencies have been assigned and said respective second fields identify said assigned frequencies so that said second fields each include said first indicator indicating that their representative frequency is assigned to their respective cell.

20. A computer-readable medium of instructions as claimed in claim 17, further comprising:
a fifth set of instructions for deallocating at least one frequency from at least one of said cells; and
a sixth set of instructions for modifying the one of said elements whose first field identifies said one of said cells and said second field identifies said frequency so that said second field includes said second indicator indicating that said frequency has been removed from said one of said cells.

21. A computer-readable medium of instructions as claimed in claim 20, wherein:
said fifth set of instructions de-assigns a plurality of frequencies from a plurality of said cells; and
said sixth set of instructions modifies those of said elements whose respective first fields identify those of said cells from which said frequencies have been removed and said respective second fields identify said removed frequencies so that said second fields each include said second indicator indicating that their representative frequency has been removed from their respective cell.

22. A computer-readable medium of instructions as claimed in claim 17, wherein:
said network segregates said cells into a plurality of respective groups of said cells, each of said respective groups having available a respective frequency spectrum, one of said respective frequency spectrums including certain of said frequencies different from any frequencies in at least one other of said frequency spectrums; and
said instructions further includes:
a seventh set of instructions for assigning to at least one of said cells at least one frequency from among said frequencies included in said frequency spectrum available to said group including said at least one cell; and
an eighth set of instructions for modifying the one of said elements whose first field identifies said one of said cells and said second field identifies said at least one frequency so that said second field includes said first indicator indicating that said frequency has been assigned to said one of said cells.

23. A system for assigning at least one frequency to at least one cell of a plurality of cells of a communications network, said cell being included among one of a plurality of respective groups of said cells, each of said respective groups having available a respective frequency spectrum, at least two of said respective frequency spectrums being different from each other, the system comprising:
means for determining whether any frequency has been assigned to any cell within a predetermined distance from said cell;
means for selecting at least one frequency from among said respective frequency spectrum available to said one respective group of cells, and other than said any frequency; and
means for assigning said selected frequency to said cell.

24. A system as claimed in claim 23, wherein:
said determining means determines which frequencies have been assigned to any cells within said predetermined distance from said cell;
said selecting means selects a plurality of frequencies from among said respective frequency spectrum available to said one respective group of cells, and other than any of said frequencies that have been assigned to said cells within said predetermined distance from said cell; and
said assigning means assigns said plurality of frequencies to said cell.

25. A system as claimed in claim 23, further comprising:
a second means for selecting one frequency from among said frequency assigned to said cell; and
means for removing at least one of said frequencies from at least one of said cells; and
wherein said second selecting means selects one frequency from among said frequencies assigned to said cell, and said removing means removes said frequency from said cell.

26. A system as claimed in claim 23, wherein:
said communications network comprises a satellite-based communications network including at least one satellite which generates at least one spot beam including said cells; and
said determing means, selecting means, and assigning means perform their respective operations on said cells included in said spot beam.

27. A system as claimed in claim 23, wherein:
said at least two frequency spectrums includes at least one of the same frequencies.

28. A system for assigning frequencies to a plurality of cells of a communications network, the system comprising:
means for generating a matrix including a number of elements, said number being equal to a total number of said cells multiplied by a total number of said frequencies, each of said elements including a first field identifying a respective said cell and a second field identifying a respective frequency from among said frequencies; and
means, for each of said elements, for providing a first indicator in said second field when said respective frequency identified by said second field is assigned to said cell identified by said first field, and providing a second indicator in said second field when said respective frequency identified by said second field is not assigned to said cell identified by said first field.

29. A system as claimed in claim 28, further comprising:
means for assigning at least one frequency to at least one of said cells; and
means for modifying the one of said elements whose first field identifies said one of said cells and said second field identifies said frequency so that said second field includes said first indicator indicating that said frequency is assigned to said one of said cells.

30. A system as claimed in claim 29, wherein:
said assigning means assigns a plurality of frequencies to a plurality of said cells; and
said modifying means modifies those of said elements whose respective first fields identify those of said cells to which said frequencies have been assigned and said respective second fields identify said assigned frequencies so that said second fields each include said first indicator indicating that their representative frequency is assigned to their respective cell.

31. A system as claimed in claim 28, further comprising:
means for removing at least one frequency from at least one of said cells; and
means for modifying the one of said elements whose first field identifies said one of said cells and said second field identifies said frequency so that said second field includes said second indicator indicating that said frequency has been de-assigned from said one of said cells.

32. A system as claimed in claim 28, wherein:
said removing means removes a plurality of frequencies from a plurality of said cells; and
said modifying means modifies those of said elements whose respective first fields identify those of said cells from which said frequencies have been removed and said respective second fields identify said removed frequencies so that said second fields each include said second indicator indicating that their respective frequency has been removed from their respective cell.

33. A system as claimed in claim 28, wherein:
said network segregates said cells into a plurality of respective groups of said cells, each of said respective groups having available a respective frequency spectrum, one of said respective frequency spectrums including certain of said frequencies different from any frequencies in at least one other of said frequency spectrums; and
said system includes:
a second means for assigning to at least one of said cells at least one frequency from among said frequencies included in said frequency spectrum available to said group including said at least one cell; and
a second means for modifying the one of said elements whose first field identifies said one of said cells and said second field identifies said at least one frequency so that said second field includes said first indicator indicating that said frequency has been assigned to said one of said cells.
